(19) United States
(12) Patent Application Publication
(10) Pub. No.: US 2004/0158444 A1
(43) Pub. Date: Aug. 12, 2004

(54) Apparatus and method for simulating electrical current with a fluid flow

(76) Inventor: Anthony M. Hasenour, DeKalb, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 10/361,537

(22) Filed: Feb. 10, 2003

(51) Int. Cl. G06F 17/50

(52) U.S. Cl. 703/8

(57) ABSTRACT

A simulator simulates battery discharge and charge by utilizing a visible fluid flow in conjunction with an electrical system. A display includes one or more switched vehicle accessories (211, 215, 219, 223) in conjunction with fluid running through one or more see-through tubes (301, 303, 305, 307, 309). A tank (101, 103) imitates the battery, and the fluid level is visible through a transparent panel in the tank (101). The fluid level in the tank (101) falls as vehicle start is simulated and/or accessories (211, 215, 219, 223) are turned on. When the fluid level in the tank (101) is low enough, the starter fails to operate, indicating that sufficient charge to start the battery is not present. As the fluid level continues to fall, the power to the accessories is reduced, until the electrical devices (211, 215, 219, 223) fail to operate, simulating a dead battery.

### FIELD OF THE INVENTION

This invention relates to educational systems, including but not limited to a system for visually demonstrating charging and discharging of a battery.

### BACKGROUND OF THE INVENTION

Vehicles containing internal combustion engines rely on batteries to provide power to start the vehicle and, when the vehicle's engine is turned off, to provide power to various accessories in the vehicle, such as headlights, 4-way flashers, a heater fan, a radio, and so forth.

Often, when a vehicle is utilized to make deliveries and/or pick-ups of packages or other items, the driver may let the engine idle or turn off the engine to save on fuel, but may leave the headlights, 4-way flashers, heater, and radio on. This activity drains the battery the longer the accessories are on without the alternator charging the battery. Recharging of the battery after such a discharge may take some time, and if the vehicle makes regular stops, the battery may not have time to sufficiently recharge. If this process continues for a prolonged period of time, the battery may not have enough charge left to start the vehicle. In order to start the vehicle again, a tow truck may be needed to “jump” the battery, and the battery will need to be charged for a period of time to insure that the vehicle will start the next time. Repeated discharge of a battery may significantly reduce the lifetime of the battery. Thus, a discharged battery may be very costly, and when a fleet of delivery vehicles is involved, a significant expense is involved when a high reoccurrence of discharged batteries takes place. The drivers of such vehicles are typically not aware of the nature of charging and discharging of a battery and the effect of running electrical devices on the battery life.

Accordingly, there is a need for a way to demonstrate the charging and discharging of a battery for vehicle operators.

### SUMMARY OF THE INVENTION

A simulator that simulates electrical current with a fluid flow includes a tank having a transparent panel and containing a fluid such that a level of fluid in the tank is visible through the transparent panel. An accessory pump is arranged to pump fluid from the tank and into a supply tube. An electronically-controlled valve is coupled to the supply tube and to a see-through tube such that when the first electronically-controlled valve is electronically activated, it opens and fluid from the supply tube travels through the first electronically-controlled valve and into the first see-through tube. An electrical component is connected in series with a component switch and connected in parallel with the electronically-controlled valve, such that when the component switch is activated, electrical power is provided to the first electrical component, the first electronically-controlled valve is activated, and the level of fluid, visible through the transparent panel, is lowered.

### BRIEF DESCRIPTION OF THE DRAWINGS

FIG. 1 is a diagram of a mechanical system for a simulator that demonstrates battery discharge and charge in accordance with the invention.

FIG. 2 is a diagram of an electrical system for the simulator that demonstrates battery discharge and charge in accordance with the invention.

FIG. 3 is a diagram of a front side of the simulator in accordance with the invention.

FIG. 4 and FIG. 5 are top-side views of an inside of a tank utilized with the simulator in accordance with the invention.

FIG. 6 is a diagram of a back side of the simulator in accordance with the invention.

FIG. 7 and FIG. 8 are views of the inside of the simulator in accordance with the invention.

FIG. 9 is a front view of multiple-position switch for use with the simulator in accordance with the invention.

FIG. 10 is a front view of an operator for a variable-position valve for use with the simulator in accordance with the invention.

### DESCRIPTION OF A PREFERRED EMBODIMENT

The following describes an apparatus for and method of simulating battery discharge and charge by utilizing a visible fluid flow in conjunction with an electrical system. A simulator includes a display with one or more switched vehicle accessories in conjunction with one or more see-through tubes having a fluid running through them. Fluid level in a tank imitating the battery is visible through a transparent panel in the tank. As the vehicle is started and/or accessories are turned on, the fluid level in the tank falls accordingly, and the fluid travels through the see-through tubes through a valve associated with the activated electrical device. When the fluid level is low enough, the starter fails to operate, indicating that sufficient charge to start the engine is not present. As the fluid level continues to fall, the power to the accessories is reduced, for example, by manually dimming the lights and/or slowing down a heater fan, until the electrical devices fail to operate due to a discharged or dead battery.

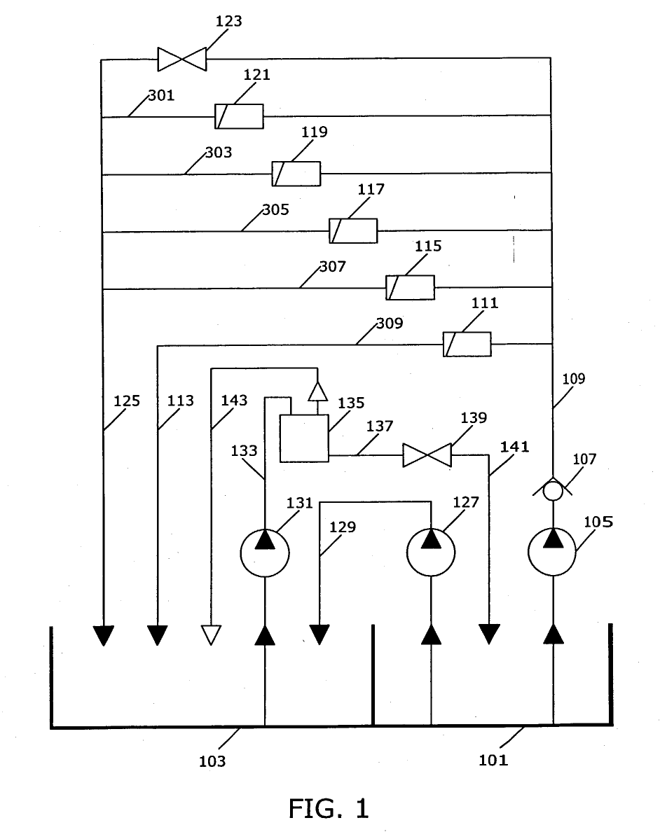

A diagram of a mechanical system for a simulator that demonstrates battery discharge and charge is shown in FIG. 1. A tank filled with a fluid, such as water, simulates a vehicle battery. The tank has two sections, a visible section 101 and a reserve section 103, that may be formed with two individual tanks or a single tank divided into two parts. An accessory pump 105 pumps fluid from the visible section 101 through a check valve 107 and into supply tube 109. Because the fluid is pumped in an upward direction, the check valve 107 prevents fluid from flowing back into the accessory pump 105 when it is not activated.

The supply tube 109 provides fluid to one or more electronically-controlled valves. Many types of electronically-controlled valves are known. For example, the electronically-controlled valves may be solenoid-controlled valves. Other types of valves, such as pneumatically-controlled valves, hydraulically-controlled valves, and/or air-actuated valves may be utilized. Each electronic control device, such as a solenoid, has an associated valve, and each electronic control device and associated valve will be referred to by the same reference numeral herein. Fluid from the supply tube 109 is provided to a valve 111 for a starter, enters a see-through tube 309, and flows into the reserve section 103 of the tank through a transfer tube 113. The transfer tube 113 and see-through tube 309 may be the same tube. Fluid from the supply tube 109 is provided to a valve 115 for headlights, enters a see-through tube 307, and flows into the reserve section 103 of the tank through a return tube 125. Fluid from the supply tube 109 is also provided to a valve 117 for a heater fan, enters a see-through tube 305, and flows into the reserve section 103 of the tank through the return tube 125. Fluid from the supply tube 109 is also provided to a valve 119 for 4-way flasher lights, enters a see-through tube 303, and flows into the reserve section 103 of the tank through the return tube 125. Fluid from the supply tube 109 is also provided to a valve 121 for a cargo or dome light, enters a see-through tube 301, and flows into the reserve section 103 of the tank through the return tube 125.

A variable-position valve 123, such as a butterfly valve, is utilized to increase pressure for the supply tube 109 to direct flow to the electronically controlled valves 111, 115, 117, 119, and 121. The variable-position valve 123 is typically at least partially open, and stays in position once set. The variable-position valve 123 is in parallel with the other valves 111, 115, 117, 119, and 121.

When activated, a start pump 127 pumps fluid from the visible section 101 to the reserve section 103 of the tank via a feed tube 129. When activated, a refill pump 131 pumps fluid from the reserve section 103 of the tank to a transfer tank 135 via a feed tube 133. Fluid from the transfer tank 135 travels through a feed tube 137 to a variable-position valve 139, such as a butterfly valve, that controls the rate of fluid transfer into the visible section 101 of the tank via a feed tube 141. An air transfer tube 143 is also provided from the transfer tank 135 to the reserve section 103 of the tank to remove excess air. The air transfer tube 143 may also be utilized to transfer excess fluid from the transfer tank 135 to the reserve section 103 of the tank. Alternatively, the transfer tank 135, feed tubes 133 and 137 and air transfer tube 143 may be eliminated and replaced with a feed tube from the refill pump 131 to the variable-position valve 139.

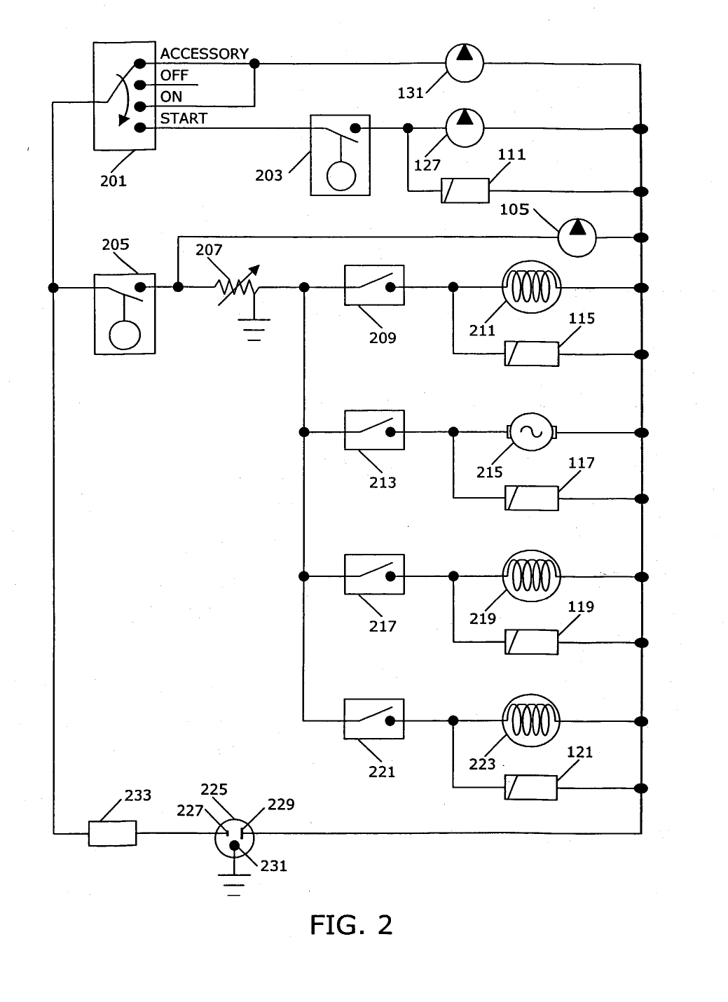

A diagram of an electrical system for the simulator that demonstrates battery discharge and charge is shown in FIG. 2. A multiple-position switch 201 is directly or indirectly connected to two of the pumps 127 and 131. For the purpose of demonstration, the multiple-position switch 201 advantageously has four positions: accessory, off, on, and start. The multiple-position switch 201 may optionally have a spring return from the “start” position to the “on” position. Although an ignition switch with its ignition key for an internal combustion engine ideally performs these functions, other multiple-position switches may be utilized.

When the multiple-position switch 201 is in the “off” position, no power is supplied to any device through the switch 201. When the multiple-position switch 201 is in the “start” position, power is supplied through a first float switch 203, when closed, to the start pump 127 and its associated electronically-controlled valve 111. The first float switch 203 remains closed until the fluid in the visible section 101 of the tank falls below a first threshold. When the multiple-position switch 201 is in the “accessory” or “on” position, power is supplied to the refill pump 131.

Power is always provided to a second float switch 205. The second float switch 205 remains closed until the fluid in the visible section 101 of the tank falls below a second threshold. No matter what position the multiple-position switch is in, when the second float switch 205 is closed, power is supplied to the accessory pump 105. Likewise, when the second float switch 205 is closed, power is also supplied through a variable dimmer switch 207, such as a rheostat, to one or more component switches 209, 213, 217, and 221. Each component switch 209, 213, 217, and 221, such as a toggle switch, controls the supply of power to its own electrical component, such as the headlights 211, the heater fan 215, the 4-way flashers 219, and the dome or cargo light 223.

Each electrical component 211, 215, 219, and 223 is connected in parallel with one of the electronically-controlled valves 115, 117, 119, and 121, such that when power is provided to the electrical component 211, 215, 219, or 223, it is simultaneously provided to its associated electronically-controlled valve 115, 117, 119, or 121. When power activates one of the electronically-controlled valves, the electronic control device, such as a solenoid, acts as a switch to open the associated valve, thereby allowing fluid to flow through the valve.

Power is provided to the electrical components via an AC (alternating current) power cord 225 that provides a hot connection 227, a neutral connection 229, and a ground connection 231. A power severing device 233, such as a fuse or circuit breaker, is also provided. The simulator may be plugged into a standard 120 V AC power outlet.

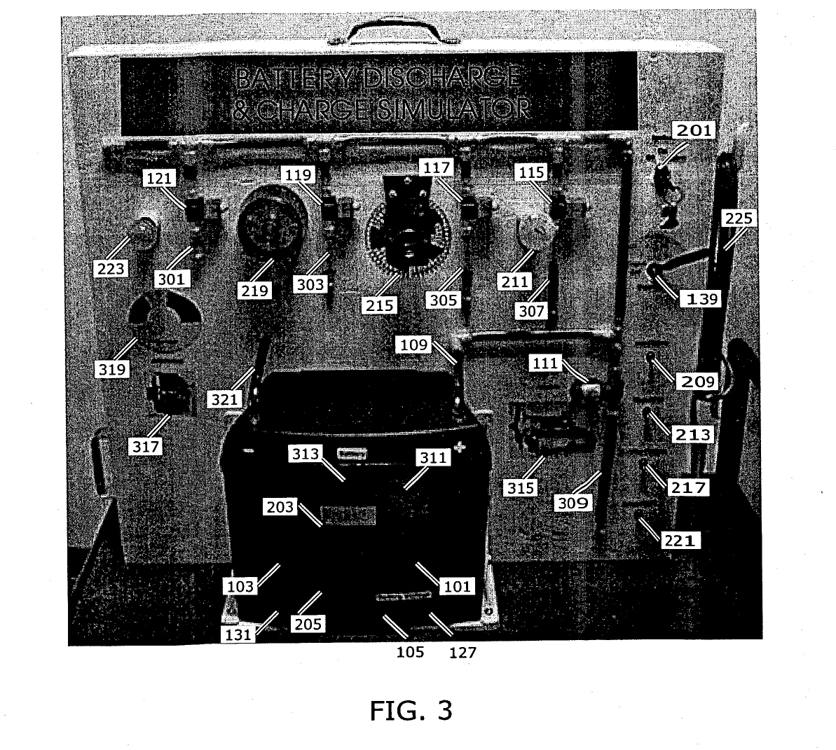

A diagram of a front side of the simulator is shown in FIG. 3. A tank having a visible section 101 and a reserve section 103 that are encased in a housing has an external appearance similar to a vehicle battery. The supply tube 109 comes out of the battery as if it were a power cable attached to the positive terminal of the battery. An additional tube 321 is placed to simulate the negative terminal of the battery. The additional tube 321 may be a “dummy” tube painted blue or may be one of the return tubes 113 or 125.

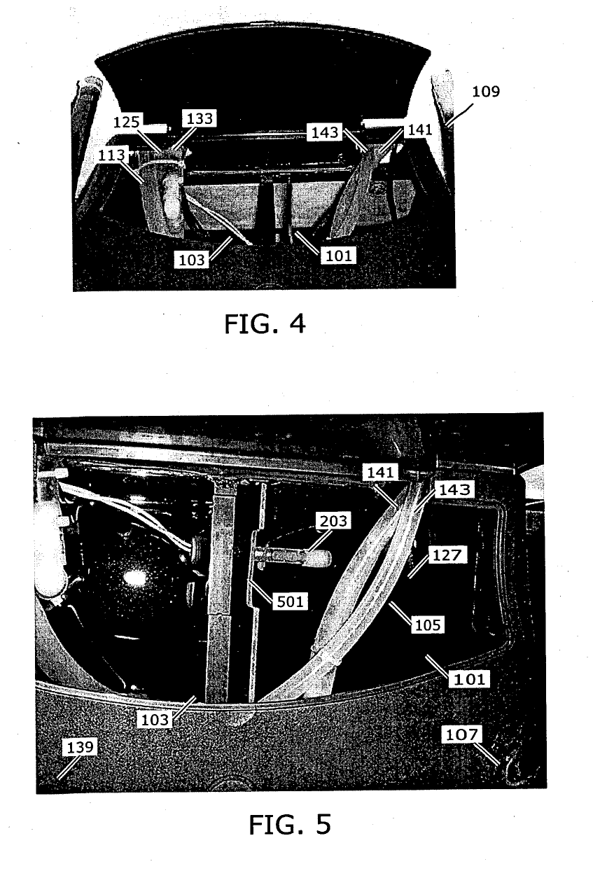

The start pump 127, the accessory pump 105, and the float switches 203 and 205 are disposed in the visible section 101 of the tank, and the refill pump 131 is disposed in the reserve section 103 of the tank. Top-side views of an inside of the tank utilized with the simulator are shown in FIG. 4 and FIG. 5. Advantageously, the reserve section 103 of the tank has more capacity that the visible section 101 of the tank. In the event that too much fluid enters one of the sections 101 and 103, a cut-out 501 between the two sections 101 and 103 allows fluid to flow between the sections 101 and 103.

While the multiple-position switch 201 is in the “start” position, and as long as the first float 203 remains above an upper threshold of fluid level in the visible section 101 of the tank, power is supplied to the start pump 127, which rapidly pumps fluid from the visible section 101 of the tank into the reserve section 103 of the tank. The level of fluid in the visible section 101 of the tank noticeably and significantly lowers, indicating that a significant amount of charge from the battery was utilized to start the vehicle. In addition, the electronically-controlled valve 111 is activated when power is supplied to the start pump 127, thus the valve 111 associated with the starter opens, allowing fluid from the supply tube 109 to flow into the starter's see-through tube 309. When the multiple-position switch 201 is switched from the “start” position to the “on” position, power is no longer supplied to the first float switch 203, thus power is no longer provided to the start pump 127. The start pump 127 and its associated tube 129 are optional.

When a component switch 209, 213, 217, and/or 221 is closed, power is supplied to its associated electrical component 211, 215, 219 and/or 223 and to the electrical component's electronically-controlled valve 115, 117, 119, and/or 121. For example, when the component switch 209 is closed, power is supplied to the headlights 211, which light up, and to the electronic control device 115, opening its associated valve. When the component switch 213 is closed, power is supplied to the heater fan 215, which spins, and to the electronic control valve 117, opening its associated valve. When the component switch 217 is closed, power is supplied to the 4-way flashers 219, which light up, and to the electronic control device 119, opening its associated valve. When the component switch 221 is closed, power is supplied to the dome or cargo light 223, which lights up, and to the electronic control device 121, opening its associated valve. Each of the component switches 209, 213, 217, and 221 is independent of the others, thus the component switches may be open or closed in any combination. Although four electrical components are shown in the drawings, any number of electrical components may be utilized. Different electrical components may be utilized in addition to or in place of those shown, including a radio/tape deck/CD player, two-way radio, data terminal, lighter, devices running off the lighter plug, turn signals, defrosters, fog lights, horn, and so forth.

When power is supplied to the accessory pump 105, fluid is pumped into the supply tube 109 that feeds fluid to the valves associated with the electronically-controlled valves 111, 115, 117, 119, and 121. When any of the component switches 209, 213, 217, and/or 221 are closed, fluid travels through the supply tube 109, through the associated valve(s) 115, 117, 119, and/or 121, and into the see-through tubes 307, 305, 303, and 301 associated with the valve(s) 115, 117, 119, and 121, thus the electronic components 211, 215, 219, and 223 operate or turn on. For example, if component switches 209 and 217 are closed, the headlights 211 and 4-way flashers 219 turn on, the electronic control devices 115 and 119 open their respective valves, and fluid flows into the see-through tubes 307 and 303. Because the fluid flowing into the see-through tubes 309, 307, 305, 303, and 301 comes from the visible section 101 of the tank, the level of fluid in the visible section 101 of the tank lowers gradually as long as any of the electrical components is activated.

The variable-position valve 139, which simulates engine speed, is utilized to refill the visible section 101 of the tank. A close-up of the variable-position valve 139 from FIG. 10 shows that a more open valve 139 simulates higher engine speed (RPM), whereas a more closed valve 139 simulates lower engine speed. Typically, the longer and faster the “engine runs,” the more charge is replaced in the battery by the alternator, as simulated by a rising level of fluid in the visible section 101 of the tank. In the example shown, fluid is transferred from the transfer tank 135 into the visible section 101 of the tank. Alternatively, fluid may be taken from the reserve section 103 of the tank, for example, when no transfer tank 135 is utilized.

A number of visual aids are provided with the simulator. The visible section 101 of the tank includes a transparent panel 311 such that the level of fluid in the visible section 101 of the tank is observable without having to open the battery housing. Next to the transparent panel 311 is a fluid level indicator 313 that is shown with three different sections. The top section of the fluid level indicator 313, which may be colored green, indicates that the battery has a good level of charge. The middle section of the fluid level indicator 313, which may be colored yellow, indicates that the battery has a reduced charge. The first float switch 203 is positioned such that the float switch opens when the level of fluid in the battery falls below the middle section of the fluid level indicator 313. When the first float switch 203 opens, any attempt to place the multiple-position switch 201 in the start position will not result in the start pump 127 turning on, thus indicating that the battery does not have enough charge to start the vehicle, although the accessories may be powered. The bottom section of the fluid level indicator 313, which may be colored red, indicates a level of fluid below the first float switch 203 and shows that the battery does not have enough charge to start the vehicle. The second float switch 205 is placed at or near the bottom of the visible section 101 of the tank. When the level of fluid falls below the second float switch 205, it opens and power to the accessory pump 105 and the electrical components 211, 215, 219, and 223 is inhibited, simulating a dead battery.

Other visual aids that are provided include a photograph of a starter 315, although an actual starter may be mounted, and a photograph of an alternator 317, although an actual alternator may be mounted, including a diagram of a color-coded alternator output gauge 319 that correlates engine speed with the amount of charge provided by the alternator. The colors utilized on the alternator output gauge 319 may be green, yellow, and red, as used in the color scheme of the fluid level indicator 313, to represent the level of charge provided to the battery by the alternator at various engine speeds. Photographs are utilized to spare expense, reduce weight, and conserve space on the simulator's two-dimensional surface. The two-dimensional surface, which may be plywood painted white, is utilized to display the various demonstrative items, such as the switches 209, 213, 217, and 221, the electrical components, 211, 215, 219, and 223, electronically-controlled valves 111, 115, 117, 119, and/or 121 the supply tube 109, see-through tubes 301, 303, 305, 307, and 309, multiple-position switch 201, variable-position valve 139, the photographs 315 and 317, and the diagram 319.

The supply tube 109 and the see-through tubes 301, 303, 305, 307, and 309 are made of a transparent or see-through material, such as plastic. The lengths of the part of the see-through tubes 301, 303, 305, 307, and 309 that are displayed on the front of the simulator display are proportional to the amount of current drawn by the particular electrical device associated with that tube. For example, the dome or cargo light 223 utilizes the least amount of current among the accessories, thus its associated see-through tube 301 has the shortest length. The starter 315 utilizes the most current of any electrical device, thus its associated see-through tube 309 has the longest length.

The pumps 105, 127, and 131 may be aquarium pumps that are disposed in the sections 101 and 103 of the tank.

Electrical components 315, 211, 215, 219, and 223 are shown in close proximity to their associated electronically-controlled valves 111, 115, 117, 119, and 121 and see-through tubes 309, 307, 305, 303, and 301 that illustrate relative current draw.

Advantageously, the fluid is colored for ease of visibility through the tubes 109, 301, 303, 305, 307, and 309 and transparent panel 311 of the battery tank. A white background on the simulator renders the colored fluid more visible. For example, the fluid may be water colored with toilet bowl cleaner, which makes the water a highly visible blue color and keeps the water clear of germs and bacteria. Other coloring methods/mechanisms may be utilized. Other fluids, such as alcohol with food coloring, colored soft drinks, antifreeze, a colorful dense gas (which may require sealing off the tank 101 and 103 to the atmosphere and different type(s) of pumps), and so forth may be utilized. Alternatively, a colored background may be utilized with a clear fluid.

Physical aids for the simulator are also provided, including back doors 601 that are fastened by hinges 603 and held closed by hardware clasps 605. One or more handles 607 and wheels 609 or casters may be provided for mobility. The power cord 225 may be mounted on the side of the simulator for convenience. The simulator may alternately be powered by a direct current (DC) source such as a battery, but such a power source would need to be recharged, which may take a significant amount of time versus simply plugging the simulator into an AC source.

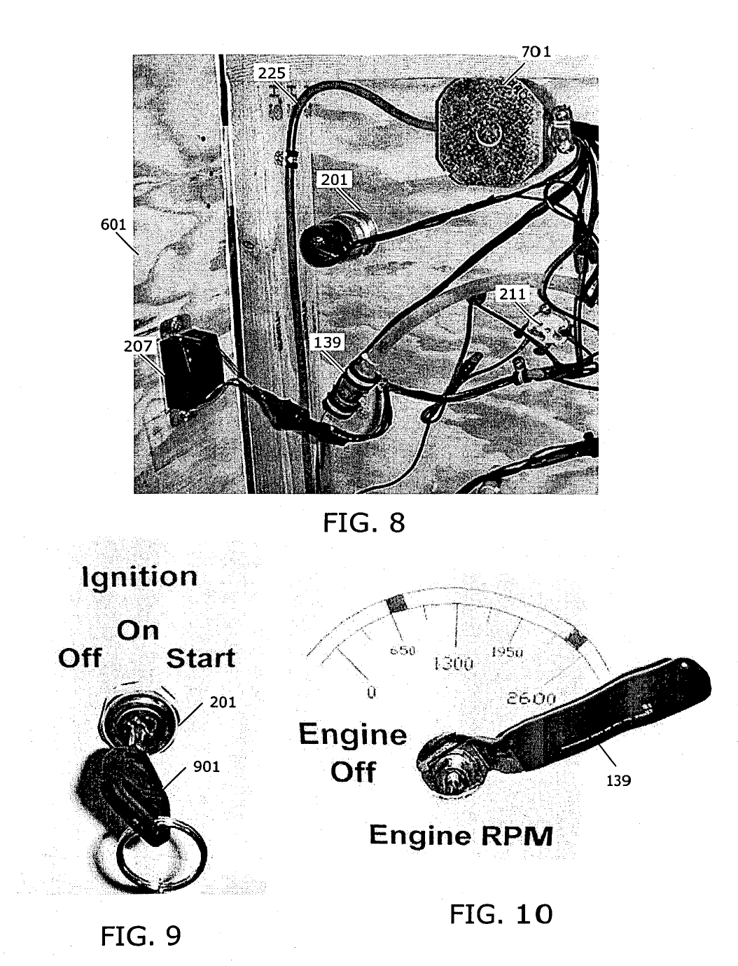

A view of the inside of the simulator is shown in FIG. 7. The majority of the electrical wiring is mounted on the inside of the simulator, which is shown with its rear doors 601 open. A junction box 701, which may house the fuse or circuit breaker 233, is utilized as a point from which each electrical device is powered. The back end of various electrical devices 115, 117, 119, 121, 201, 209, 211, 213, 215, 217, 219, 221, and 223 and the power cord 225 are shown. The see-through tubes 301, 303, 305, 307, and 309 feed into the return tube 125, which enters the reserve section 103 of the tank via a feed-through hole 703 in the display. Other feed-through holes are utilized to provide vias for tubes, wiring, and various components that are mounted to the board. The variable-position valves 123 and the back of the variable-position valve 139 and their associated tubes 125, 137, and 141 are shown. The transfer tank 135 is shown mounted with its associated tubes 133, 137, and 143. Part of the dimmer switch 207 is mounted on one of the doors 601 on the inside of the simulator, as shown in FIG. 8.

An example of a demonstration of the simulator may be as follows. To begin the demonstration, the multiple-position switch 201 is switched from the “off” position to the “start” position, simulating the starting/cranking of an engine. A close-up view of the multiple-position switch 201 is shown in FIG. 9. The switch 201 utilized is an actual ignition switch from a vehicle, including an ignition key 901. Fluid rapidly flows from the visible section 101 to the reserve section 103 of the tank, simulating the large amount of charge utilized to start a vehicle. Fluid also flows in the see-through tube 309 associated with the starter 315 and valve 111.

The multiple-position switch 201 is switched from the “start” position to the “on” position, indicating that the engine is idling. Various component switches 209, 213, 217, and/or 221 are turned on, resulting in activation of the associated electrical components 211, 215, 219, and/or 223, as well as fluid flowing in the associated see-through tubes 307, 305, 303, and/or 301. At this time, the variable-position valve 139 is closed, and the fluid level in the visible section 101 of the tank slowly or gradually falls, because the alternator does not charge the battery sufficiently during engine idle. If the fluid level falls below into the lower (red) section of the fluid level indicator 313, and if the engine is turned off at this time by placing the multiple position switch 201 in the “off” position, the engine would not start again, simulating that there is not enough charge to start the vehicle.

To simulate charging of the battery by the alternator 317, the engine speed is increased as simulated by opening the variable-position valve 139, such as shown in more detail in FIG. 10. The higher the engine speed, the more quickly the fluid level rises in the visible section 101 of the tank. The longer the valve is left open, the more the fluid level rises in the visible section 101 of the tank. If the engine speed is high enough for a long enough period of time, the fluid level rises to the middle (yellow) or top (green) section of the fluid level indicator 313, indicating a recharged battery. If the fluid level rises into the middle (yellow) or top (green) section of the fluid level indicator 313, and if the engine is turned off at this time by placing the multiple position switch 201 in the “off” position, the engine may start again, simulating that there is enough charge to restart the vehicle.

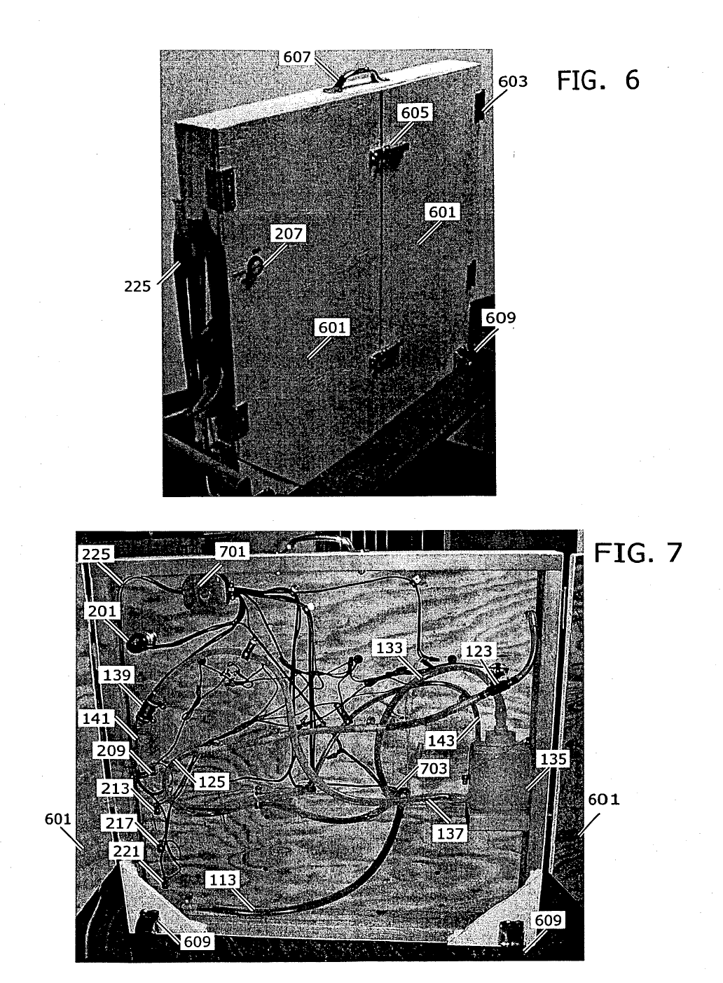

A vehicle stoppage, i.e., reducing engine speed to zero, is simulated by closing the variable-position valve 139, and optionally switching the multiple-position switch 201 from the “on” position to the “off” position if it is desired to simulate turning the engine off. If any of the electrical components 211, 215, 219, and/or 223 are left on, the level of fluid in the tank lowers accordingly. A number of vehicle stops may be simulated, and when enough stops are made in succession without charging the battery sufficiently, the fluid level falls below the level necessary to start the engine. If a significant amount of time transpires when the engine is off while the accessories, i.e., electrical components 211, 215, 219, and/or 223, are left on, the electrical power to these components is reduced, as simulated by manually turning a dimmer switch 207, such as shown in FIG. 6. The fluid level eventually reaches in the bottom (red) section of the fluid level indicator 313. When enough energy is drained from the battery, the second float switch 205 opens, inhibiting power from reaching the electrical components 211, 215, 219, and/or 223. Alternatively, the dimmer switch 207 may be utilized to manually turn off all the electrical components 211, 215, 219, and/or 223. Thus, a dead battery is simulated.

Once the demonstration is completed, the visible section 101 of the tank may be quickly refilled for another demonstration by placing the multiple-position switch 201 in the “accessory” position (not shown in FIG. 8), just counterclockwise of the “off” position in FIG. 8, and opening the variable-position valve 139 to its fully open position, i.e., maximum engine speed. When the visible section 101 of the tank is sufficiently filled, the multiple-position switch 201 is placed in the “off” position.

The simulator serves as a visual aid to educate vehicle operators about the electrical systems in vehicles. The simulator demonstrates how electrical loads such as starters, headlights, 4-way flashers, heater fans, and so forth affect the electrical power system, including the battery and alternator. Visual representations of battery voltage level and supplied electrical current are provided for various electrical loads in the form of a visible fluid. The simulator shows how driving conditions combined with undesirable use of electrical vehicle accessories result in a dead battery. Various charging and discharging conditions are simulated, including relationships between engine speed and charging. Demonstrations with the simulator train vehicle operators how to reduce the occurrence of a dead battery. The simulator is reusable and mobile.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A simulator comprising:
a tank having a transparent panel and containing a fluid such that a level of fluid in the tank is visible through the transparent panel;
an accessory pump arranged to pump fluid from the tank and into a supply tube;
a first electronically-controlled valve of one or more electronically-controlled valves, wherein the first electronically-controlled valve is coupled to the supply tube and to a first see-through tube of one or more see-through tubes such that when the first electronically-controlled valve is electronically activated, the first electronically-controlled valve opens and fluid from the supply tube travels through the first electronically-controlled valve and into the first see-through tube;
a first electrical component of one or more electrical components, the first electrical component connected in series with a first component switch of one or more component switches and connected in parallel with the first electronically-controlled valve, such that when the first component switch is activated, electrical power is provided to the first electrical component, the first electronically-controlled valve is electronically activated, and the level of fluid, visible through the transparent panel, is lowered.

2. The simulator of claim 1, further comprising a start pump, arranged and constructed to rapidly pump the fluid out of the tank when a multiple-position switch is placed in a first position.

3. The simulator of claim 1, further comprising a refill pump, arranged and constructed to rapidly pump the fluid into the tank when a multiple-position switch is placed in a second position.

4. The simulator of claim 1, further comprising a first float switch disposed in the tank at a first level, such that when the level of fluid in the tank falls below the first level, the first float switch inhibits power from reaching a start pump that rapidly pumps the fluid out of the tank when a multiple-position switch is placed in a first position.

5. The simulator of claim 1, further comprising a second float switch disposed in the tank at a second level, such that when the level of fluid in the tank falls below the second level, the second float switch inhibits power from reaching the one or more electrical components.

6. The simulator of claim 1, further comprising a dimmer switch arranged and constructed to reduce current provided to the one or more electrical components.

7. The simulator of claim 1, further comprising a butterfly valve coupled to a supply of fluid such that fluid from the supply of fluid passes through the butterfly valve and into the tank, thereby increasing the level of fluid in the tank at a rate based on how open the butterfly valve is.

8. The simulator of claim 1, wherein the tank is comprised of a first tank section and a second tank section, wherein the first tank section includes the transparent panel, and wherein a start pump pumps the fluid from the first tank section to the second tank section when a multiple-position switch is placed in a first position.

9. The simulator of claim 8, further comprising a transfer tank, wherein the refill pump pumps fluid from the second tank section to the transfer tank.

10. The simulator of claim 9, further comprising a butterfly valve coupled to the transfer tank such that the fluid from the transfer tank passes through the butterfly valve and into the first tank section, thereby increasing the level of fluid in the first tank section at a rate based on how open the butterfly valve is.

11. The simulator of claim 1, wherein the multiple-position switch is an ignition switch for a vehicle driven by an internal combustion engine.

12. The simulator of claim 1, wherein the fluid has a color that is visible through at least one of the one or more see-through tubes.

13. The simulator of claim 1, wherein the multiple-position switch, the one or more electronically-controlled valves, the one or more electrical components, the one or more component switches, and the one or more see-through tubes are displayed on a two-dimensional surface.

14. The simulator of claim 1, wherein each of the one or more see-through tubes is associated with one of the one or more electrical components, and a visible length of each of the one or more see-through tubes is proportional to the amount of current drawn by the associated one of the one or more electrical components.

15. The simulator of claim 1, wherein the one or more electrical components are each vehicle accessories, including at least one of a heater fan, headlights, a radio, 4-way flashers, and a cargo light.

16. A method of simulating electrical current with a fluid flow comprising the steps of:
providing a tank containing with fluid and having a transparent panel such that a level of fluid in the tank is visible through the transparent panel;
connecting an accessory pump to pump fluid from the tank and into a supply tube when a multiple-position switch is placed in a first position;
connecting a start pump to rapidly pump the fluid out of the tank when the multiple-position switch is placed in a first position;
arranging a first electronically-controlled valve of one or more electronically-controlled valves such that when the first electronically-controlled valve opens, fluid from the supply tube travels through the first electronically-controlled valve and into a first see-through tube coupled to the first electronically-controlled valve;
connecting a first electrical component, of one or more electrical components, in series with a first component switch of one or more component switches and in parallel with the first electronically-controlled valve, such that when the first component switch is activated, electrical power is provided to the first electrical component, the first electronically-controlled valve is electronically activated, and the level of fluid visible through the transparent panel falls;
coupling a variable-position valve to a supply of fluid, such that fluid from the supply of fluid passes through the variable-position valve and into the tank, thereby increasing the level of fluid in the tank.

17. The method of claim 16, further comprising the steps of:
disposing a first float switch in the tank at a first level, such that when the level of fluid in the tank falls below the first level, the first float switch inhibits power from reaching the start pump; and
disposing a second float switch the tank at a second level, such that when the level of fluid in the tank falls below the second level, the second float switch inhibits power from reaching the one or more electrical components.

18. The method of claim 16, further comprising the step of disposing a refill pump to rapidly pump the fluid into the tank when the multiple-position switch is placed in a second position.

19. The method of claim 16, further comprising the step of displaying the multiple-position switch, the one or more electronically-controlled valves, the one or more see-through tubes, the one or more electrical components, and the one or more component switches on a two-dimensional surface.

20. The method of claim 16, wherein each of the one or more see-through tubes is associated with one of the one or more electrical components, further comprising the step of sizing each of the one or more see-through tubes proportional to the amount of current drawn by the associated one of the one or more electrical components.
